(19) United States
(12) Patent Application Publication
(10) Pub. No.: US 2007/0144030 A1
(43) Pub. Date: Jun. 28, 2007

(54) FLOW-THROUGH DRYER

(76) Inventors: Helio Ribeiro, Newark, NJ (US); William Sellars, Milwaukee, WI (US); Crawford Williams, West Chester, PA (US); Ron Charno, Drexel Hill, PA (US); John Kawand, Titusville, NJ (US)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(21) Appl. No.: 11/683,076

(22) Filed: Mar. 7, 2007

Related U.S. Application Data
(63) Continuation of application No. 10/246,776, filed on Sep. 17, 2002, now abandoned.
(60) Provisional application No. 60/322,868, filed on Sep. 17, 2001.

(51) Int. Cl. D06F 58/00; F26B 3/00

(52) U.S. Cl. 34/115; 34/122; 34/453

(57) ABSTRACT

A flow-through dryer for drying webs of material comprising a rotatable drying drum having a cylindrical drum face and section flanges on the drum ends that enclose an interior space. The drum face is configured as a series of spaced pleated vent plates mounted circumferentially about the outside of drying drum. The pleated vent plates are perforated to allow air flow into the interior space and have an outer edge that is adapted to support the web of material about the drying drum.

### CROSS REFERENCE TO RELATED APPLICATIONS

This is a continuation of U.S. application Ser. No. 10/246,776 filed Sep. 17, 2002, which claims priority U.S. Provisional Patent Application No. 60/322,868 filed Sep. 17, 2001.

### FIELD OF THE INVENTION

The present invention relates to a flow-through dryer drum used in paper, non-woven and textile manufacturing. More particularly, it relates to a structure that contains a porous vacuum drum over which webs of material (paper, non-wovens, textiles) pass over a rotating drum. As the drum rotates, air is blown and/or vacuumed through the web of material passing through the dryer or curing purposes. The air may be heated, cooled, or ambient temperature.

### BACKGROUND OF THE INVENTION

In many paper-making machines, through-air dryer units are used for evaporative drying of a web of paper. Through-air units may be used on the paper web after or instead of other drying devices, such as Yankee dryers or other pressing devices. Flow-through dryers have been used in past paper or textile manufacturing processes.

Typically, a flow-through dryer unit 10, such as the one of the present invention shown in FIG. 1, includes a hollow, rotating drying drum 12 having a porous or foraminous cylindrical drum face 14 around which the wet web 16 of paper is partially wrapped as the web is passed through the unit.

The paper web can either be supported on a continuous fabric 18 or the vacuum drum itself could be covered with a very porous material. A continuous fabric system 18 typically has a plurality of guide rolls 20 about which the fabric 18 is looped for guiding the fabric 18 about a continuous path. The fabric 18 contacts the outer surface of the drum face 14 and guides the web 16 through the flow-through dryer unit 10. An air supply hood 22 surrounds the portion of the drying drum 12 about which the fabric 18 and web 16 are wrapped and supplies heated, cooled, or ambient air through the fabric 18 and web 16 and through the drum face 14 into an interior volume 24 of the drum 12. The supply hood 22 is formed of two halves that are movable away from each other by a wheeled track so that the drum 12 can be accessed for service and cleaning.

Heated, cooled, or ambient air from the supply hood 22 passes through the porous drum face 14 and through the web 16 and fabric 18 so as to cause evaporative drying of the web or cooling of the web. An exhaust vacuum system 26 often located either on the bottom portion of the drum 12 (opposite the supply hood 22) or, preferably, on the ends of the drum 12 then exhausts air from the drum 12.

In certain past drying drums, the drum face 14 was of a honeycomb design. Such past drying drums are relatively heavy, expensive, difficult to manufacture, and are insufficiently porous. The honeycomb design subtracts from the open surface area of the outer surface such that the surface is only 70-80% open to through-air flow.

### BRIEF DESCRIPTION OF THE DRAWINGS

FIG. 1 is an end view of the preferred embodiment of a flow-through dryer unit.

FIG. 2 is a partially exploded, perspective view of a preferred embodiment of the flow-through dryer drum of the invention.

FIG. 3 is an inside perspective view of a single quadrant of a preferred embodiment of the flow-through dryer drum.

FIG. 4 is a cross-sectional detail view of the flow-through dryer drum taken from circle 4 of FIG. 2.

FIG. 5 is a perspective view of a preferred embodiment of a single pleated vent plate of the invention.

FIG. 6 is a side-view of the preferred embodiment of a single pleated vent plate of the invention.

FIG. 7 is an end view of the preferred embodiment of a single pleated vent plate of this invention.

FIG. 8 is a detailed view of the preferred embodiment of a single pleated vent plate taken along circle 8 in FIG. 6.

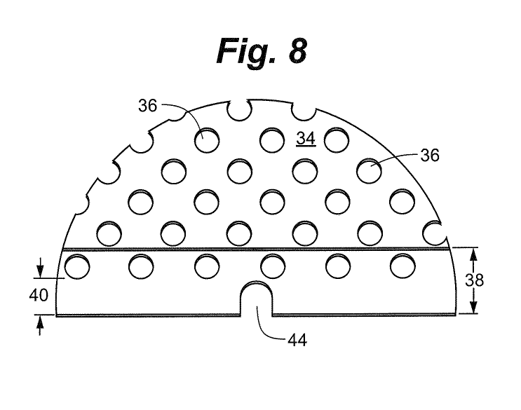

FIG. 9 is a detailed perspective of the underside of a central portion of the flow-through dryer drum.

FIG. 10 is a detailed perspective view of the underside of an end portion of the flow-through dryer drum.

### DETAILED DESCRIPTION

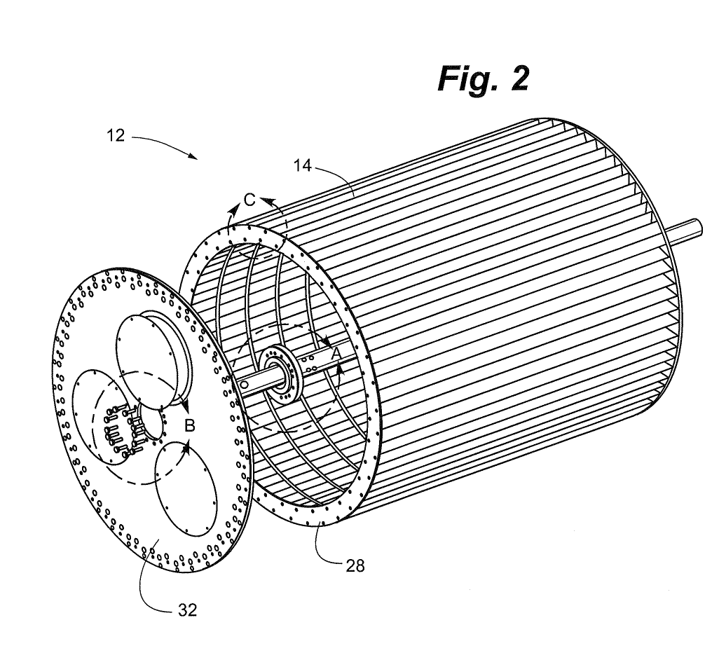

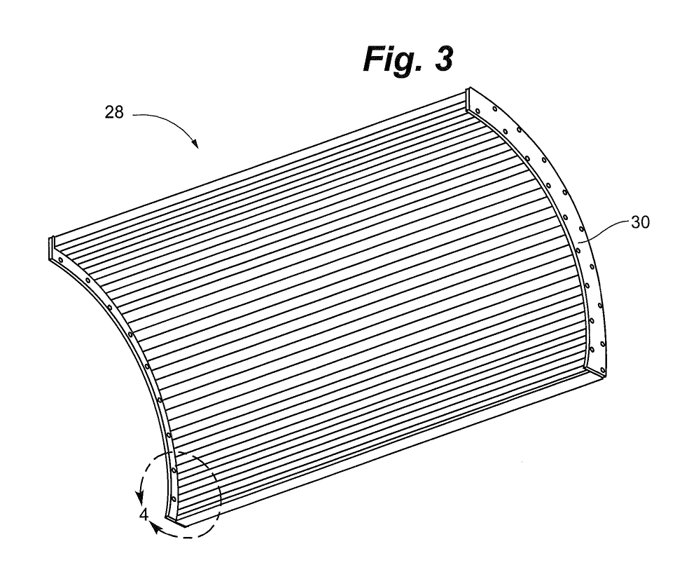

A preferred embodiment of the flow-through dryer 12 of the invention is shown in FIG. 2. The drum 12 is divided up into four generally identical sections or quadrants 28 as shown more clearly in FIG. 3. If a portion of the drum is damaged, at most only one section 28 needs to be replaced. In addition, the drum 12 is easier to manufacture when it is formed of sections. Each end of each section 28 includes an outer radially extending flange 30. The sections 28 are held together via bolt connections between the flanges 30 and circular end plates 32 that cover opposite ends of the drum 12.

The end plates 32 have several circular cutouts. The center cutout journals a drive shaft so that the drum 12 is rotatable about its central axis. The other three cutouts may be used as an access holes for servicing and cleaning.

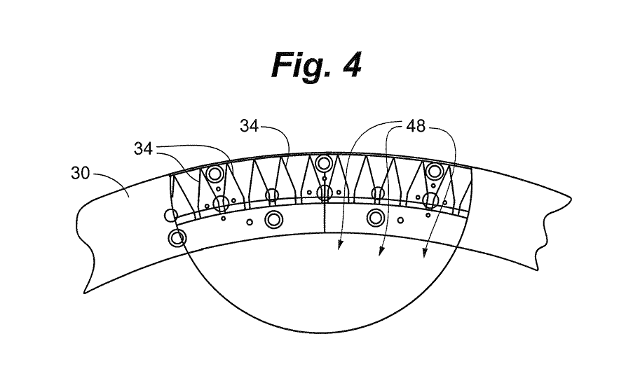

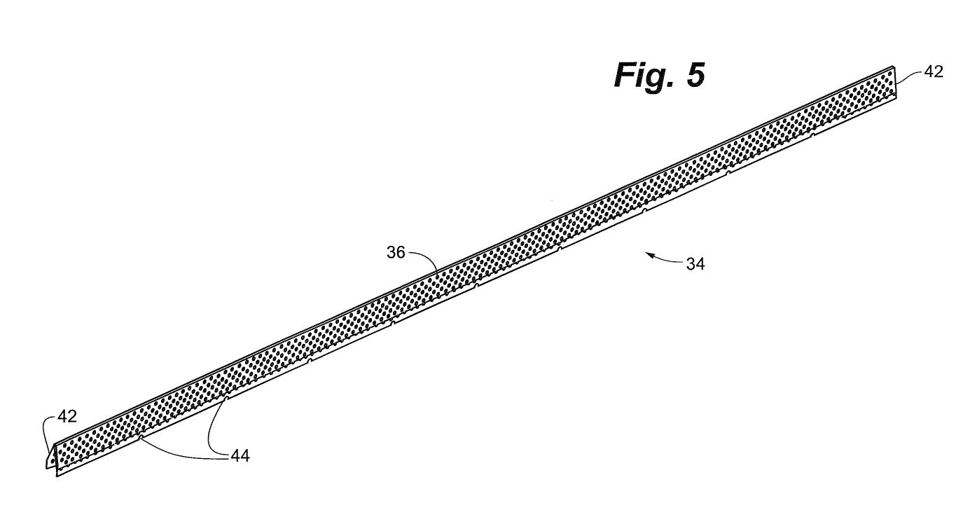

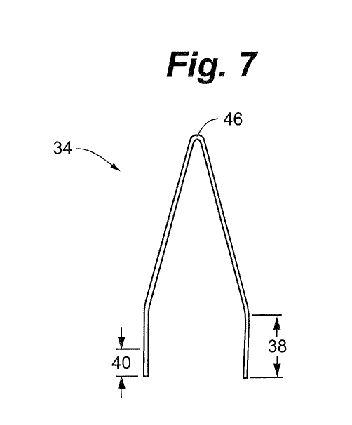

As shown best in FIG. 4, a series of equally-spaced pleated vent plates 34 are mounted circumferentially along the outside of the drum 12 and between the section flanges 30. As shown in FIGS. 5-7, each pleated vent plate 34 is a perforated 36 plate formed in the shape shown in FIG. 7. Preferably, each plate 34 may be comprised of 14-gauge stainless steel perforated 36 such that at least 40-60% of the plate area is open, without compromising the material strength, and formed into the desired shape. Many other cutout patterns 36 could be used and the percentage of open area could also vary as long as the material strength is not compromised.

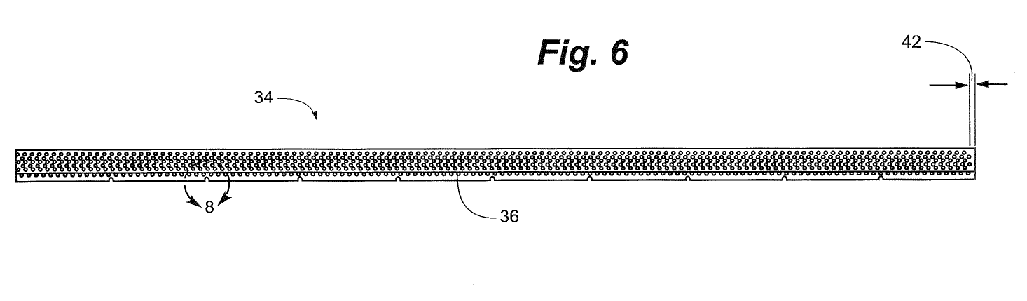

As shown in FIG. 7, the plates 34 include a base section 38 and a skirt 40, and, as shown in FIGS. 5 and 6, an end portion 42. The skirt 40 portion includes a series of spaced annular cutouts 44. Except for the annular cutouts 44 in the skirt 40, the skirt and the end portions are non-perforated. The non-perforated areas help mount the pleated vent plates 34 to the drum 12. In addition to skirts 40 and end portions 42, tips 46 of the plates 34 could be non-perforated so wear of fabric 18 could be minimized. Moreover, if flow-through dryer unit 10 were operated without the use of fabric 18, tips 46 may preferably be non-perforated so as to limit damage to the web.

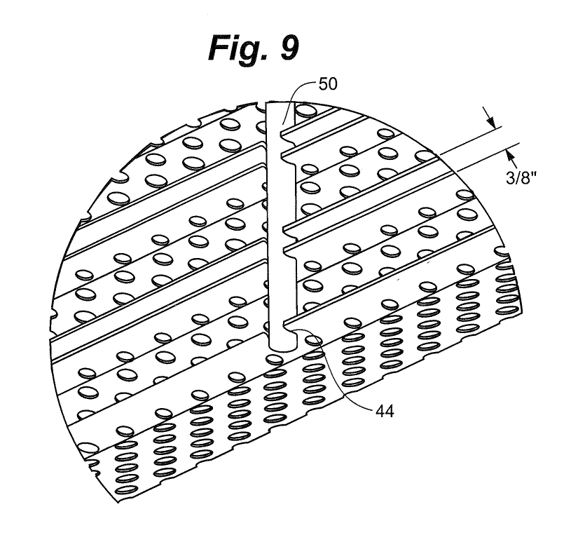

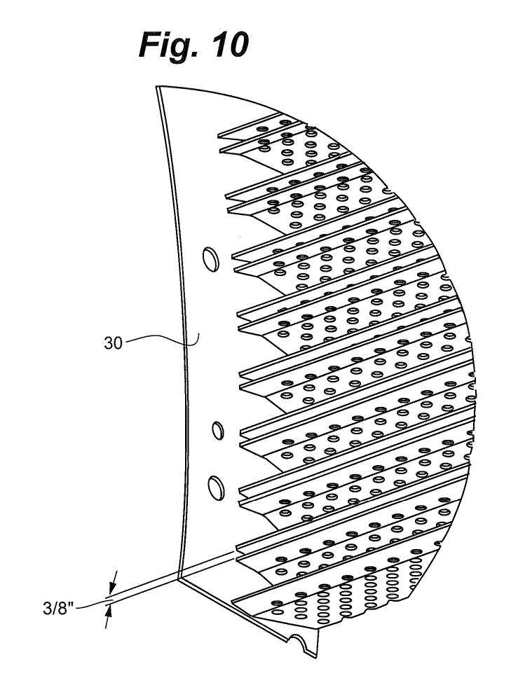

The series of pleated vent plates 34 are mounted circumferentially along the outside perimeter of the drum 12. The continuous fabric upon which the web 16 rides typically only contacts the drum face 14 at the tips 46 of the plates 34. Preferably, as shown in FIGS. 9 and 10, a circumferential gap of about ⅜″ remains between the base portions 38 of adjacent pleated vent plates 34 when they are welded or otherwise fastened to the sections 30 along the non-perforated end portions 42. Alternatively, the gap could be eliminated by either positioning the pleated vent plates against each other or by forming the pleated vent plates from a continuous sheet (i.e., making the series of plates integral formed with each other).

As shown by the airflow arrows in FIG. 4, the perforated plates and the gaps therebetween create a large number of airflow paths for air to flow in or out of the interior 24 of the drum 12. Air may flow through the perforations 36 in the plates 34 or through the gaps between the plates. The drum construction creates a corrugated or pleated structure that increases the open-air surface area of the drum face 14 over the honeycomb designs of the prior art. By pleating the perforated plates, five objectives are achieved simultaneously. First, the combined surface area is more than doubled, thereby increasing the total effective open surface area from about 60% to 120% as compared to the flat circumferential surface area. Second, the pleated design makes the drum strong. Third, the pleated design makes the drum much easier and cheaper to manufacture than past honeycomb designs. Fourth, if damaged the drum can be inexpensively repaired on-site. Finally, this pleated design can be assembled on-site in, for instance, a paper mill quickly, easily, and inexpensively. This is a benefit because some honeycombs can be 14-18 feet in diameter and require special and expensive shipping considerations. This can be extremely expensive as paper machines are located throughout the world. The honeycomb cannot be assembled on-site like the present invention can.

In addition, the shape of the perforated plates helps prevent one end plate 32 from rotating relative to the other plate 32. The perforated plates 34 are much lighter than past honeycomb designs. With decreased weight, the material and operating costs of the drum 12 are also reduced.

As stated above, a preferred cross-section of the pleated vent plate is shown in FIG. 7. Many different cross-sectional shapes are suitable, including an inverted V, U, W, Y, etc. These shapes provide an outer edge to support the web while maintaining perforated sides that extend inward (towards the cylinder center) and outward (circumferentially away from the outer edge).

The plates 34 are supported radially by a series of circular hoops 50 spaced axially along the length of the plates. Preferably, the hoops 50 are welded to the skirts 40 of the plates 34 within the annular cutouts 44. The hoops are preferably formed of stainless steel rods ½″ in diameter. Other means besides the hoops 50 could be used to provide radial support to the plates 34 to hold the tips at a consistent radius from the center axis of the drum 12. For instance, the plates could be connected together to provide radial support or another structure could be used to interconnect plates for this same purpose.

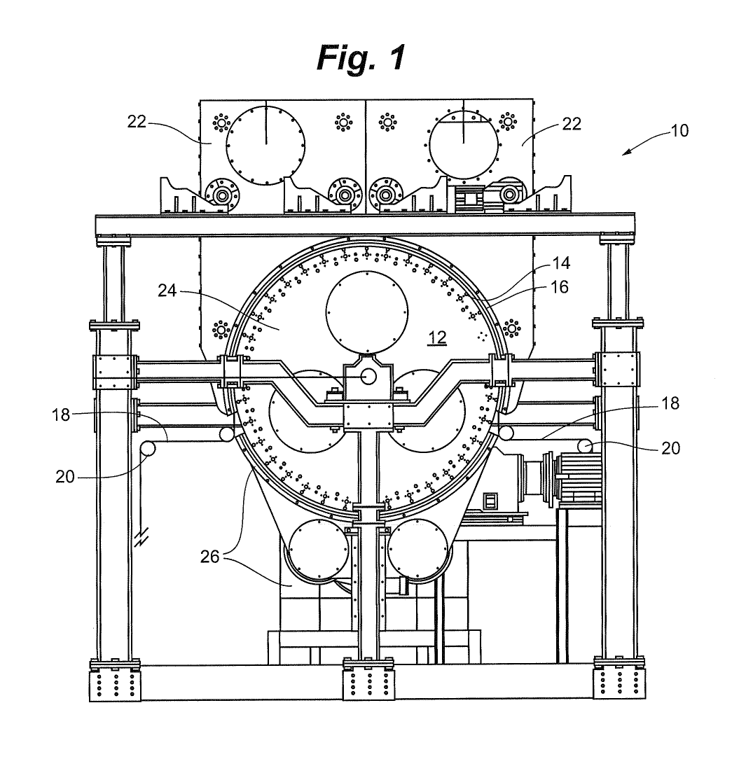

As stated above, an exhaust vacuum system 26 is often located either on the bottom portion of the drum 12 (opposite the supply hood 22), as shown in FIG. 1, or on the ends of the drum 12. The exhaust system 26 exhausts air from the drum 12.

It will be appreciated that the present invention can take many forms and embodiments. It is not intended that the embodiment of the invention presented herein should limit the scope thereof.

What is claimed is:

1. A rotatable drying drum for drying webs of material, the drum comprising a central axis and a drive shaft for rotating the drum about its central axis,
a cylindrical drum face enclosing an interior space within the drying drum, the drum face being formed from a plurality of pleated vent plates mounted circumferentially about the outside of the drying drum, the pleated vent plates being perforated to facilitate air flow through the drum face into the interior space and each having an outer edge, the outer edge adapted for supporting the webs of material about the drying drum; and
section flanges attached on opposite ends of the pleated vent plates.

2. The drum of claim 1 wherein the drying drum comprises four identical quadrants.

3. The drum of claim 1 further including circular end plates mounted on the opposite ends of the drying drum outside of the section flanges.

4. The drum of claim 1 wherein the section flanges are outer radially extending flanges.

5. The drum of claim 1 wherein the pleated vent plates are perforated such that at least 60% of their surface area is open.

6. The drum of claim 1 wherein the edges are non-perforated.

7. The drum of claim 1 wherein the pleated vent plates are spaced circumferentially apart by about ⅜ inches.

8. The drum of claim 1 wherein between each pleated vent plate an air gap is formed.

9. The drum of claim 1 wherein each pleated vent plate has perforated sides extending inward and away from the respective outer edge.

10. The drum of claim 9 wherein the sides terminate in a lower base portion having a non-perforated skirt, the base portion being located opposite the upper edge.

11. The drum of claim 10 wherein the skirts include a series of spaced annular cutouts that are configured to receive and be welded to a series of circular hoops spaced axially about a center axis extending through the cylindrical drum face.

12. The drum of claim 11 wherein the circular hoops are configured as stainless steel rods being about ½ inch in diameter.

13. The drum of claim 1 further including an air supply hood surrounding a portion of the cylindrical drum face capable of supplying air through the web and the cylindrical drum face into the interior space.

14. The drum of claim 13 further including an exhaust vacuum system positioned about a portion of the drying drum for exhausting air from the interior space.

15. The drum of claim 14 wherein the exhaust vacuum system surrounds a portion of the cylindrical drum face.

16. The drum of claim 14 wherein the exhaust vacuum system is positioned about an end of the drying drum.

17. The drum of claim 1 wherein the pleated vent plates have a cross-section of an inverted V shape.

18. A rotatable drying drum for drying webs of material, comprising:
a cylindrical drum face enclosing an interior space within the drying drum, the drum face being formed from a plurality of pleated vent plates having a cross-section of an inverted V shape mounted circumferentially about the outside of the drying drum, the pleated vent plates being perforated to facilitate air flow into the interior space and each having an outer edge, the outer edge adapted for supporting the webs of material about the drying drum; and
section flanges attached on opposite ends of the pleated vent plates.

19. A rotatable drying drum for drying webs of material, comprising:
a cylindrical drum face enclosing an interior space within the drying drum, the drum face being formed from a plurality of pleated vent plates mounted circumferentially about the outside of the drying drum, the pleated vent plates having perforated sides extending inward and away from the respective outer edge to facilitate air flow into the interior space and each having an outer edge adapted for supporting the webs of material about the drying drum; wherein the sides terminate in a lower base portion having a non-perforated skirt, the base portion being located opposite the upper edge, and
section flanges attached on opposite ends of the pleated vent plates.

20. The drum of claim 19 wherein the skirts include a series of spaced annular cutouts that are configured to receive and be welded to a series of circular hoops spaced axially about a center axis extending through the cylindrical drum face.

21. The drum of claim 20 wherein the circular hoops are configured as stainless steel rods being about ½ inch in diameter.

22. The drum of claim 1 wherein the pleated vent plates have a generally V-shaped cross-section.
